(19) United States
(12) Patent Application Publication
(10) Pub. No.: US 2023/0315026 A1
(43) Pub. Date: Oct. 5, 2023

(54) CONTROL DEVICE FOR ELECTRIC MOTOR, MACHINE SYSTEM, AND CONTROL METHOD

(71) Applicant: Fanuc Corporation, Minamitsuru-gun, Yamanashi (JP)

(72) Inventors: Shougo Shinoda, Minamitsuru-gun, Yamanashi (JP); Satoshi Ikai, Minamitsuru-gun, Yamanashi (JP)

(73) Assignee: Fanuc Corporation, Minamitsuru-gun, Yamanashi (JP)

(21) Appl. No.: 18/022,657

(22) PCT Filed: Aug. 19, 2021
(86) PCT No.: PCT/JP2021/030454

§ 371 Date: Feb. 22, 2023

(30) Foreign Application Priority Data
Aug. 24, 2020 (JP) 2020-141029

(51) Int. Cl. G05B 11/40

(52) U.S. Cl. CPC G05B 11/40

(57) ABSTRACT

A control device includes a feedback acquisition section that acquires a feedback value from an industrial machine driven by an operation of an electric motor, a correction section that corrects a command for operating the electric motor, based on the feedback value, a filter section that performs, on the feedback value to be supplied to the correction section, filtering for reducing a value in a frequency band predetermined, a driving state determination section that determines whether or not a driving state of the industrial machine is changed, and a filter switching section that switches the frequency band of the filtering to be performed by the filter section from a first frequency band to a second frequency band, when the driving state is determined to be changed.

### CROSS REFERENCE TO RELATED APPLICATIONS

This is the U.S. National Phase application of PCT/JP2021/030454, filed Aug. 19, 2021, which claims priority to Japanese Patent Application No. 2020-141029, filed Aug. 24, 2020, the disclosures of these applications being incorporated herein by reference in their entireties for all purposes.

### FIELD OF THE INVENTION

The present disclosure relates to a control device for an electric motor, a machine system, and a control method.

### BACKGROUND OF THE INVENTION

A control device for an electric motor is known (e.g., PTL 1).

### Patent Literature

PTL 1: JP 2011-123616 A

### SUMMARY OF THE INVENTION

In an industrial machine including an electric motor, a command to the electric motor may be corrected based on a feedback value from a sensor. In the related art, there is a demand for a technique that can appropriately perform such correction.

In an aspect of the present disclosure, a control device that controls an electric motor of an industrial machine includes a feedback acquisition section that acquires a feedback value from the industrial machine driven by an operation of the electric motor, a correction section that corrects a command for operating the electric motor, based on the feedback value, a filter section that performs filtering for reducing a value in a predetermined frequency band on the feedback value to be supplied to the correction section, a driving state determination section that determines whether or not a driving state of the industrial machine is changed, and a filter switching section that switches the frequency band of the filtering to be performed by the filter section from a first frequency band to a second frequency band, when the driving state determination section determines that the driving state is changed.

In another aspect of the present disclosure, a method of controlling an electric motor of an industrial machine includes acquiring a feedback value from the industrial machine driven by an operation of the electric motor, correcting a command for operating the electric motor, based on the feedback value, performing filtering for reducing a value in a predetermined frequency band on the feedback value used for the correcting, determining whether or not a driving state of the industrial machine is changed, and switching the frequency band of the filtering to be performed from a first frequency band to a second frequency band, when determining that the driving state is changed.

In accordance with the present disclosure, according to the present embodiment, a frequency band of filtering performed by a filter section is switched according to a driving state of an industrial machine, and thus it is possible to appropriately perform correction by a correction section.

### BRIEF DESCRIPTION OF DRAWINGS

FIG. 1 is a block diagram of a machine system according to an embodiment.

FIG. 2 is a diagram of an industrial machine according to an embodiment.

FIG. 3 is a block diagram illustrating an example of a control flow of an electric motor in the machine system illustrated in FIG. 1.

FIG. 4 illustrates frequency characteristics of filtering.

FIG. 5 illustrates frequency characteristics of a noise component caused by a change in a driving state of an industrial machine.

FIG. 6 illustrates frequency characteristics of the filtering.

FIG. 7 illustrates frequency characteristics of the filtering.

FIG. 8 is a flowchart illustrating an example of a filter control flow of the machine system illustrated in FIG. 1.

FIG. 9 is a block diagram illustrating another example of a control flow of the electric motor in the machine system illustrated in FIG. 1.

FIG. 10 is a block diagram illustrating still another example of a control flow of the electric motor in the machine system illustrated in FIG. 1.

FIG. 11 is a block diagram illustrating still another example of a control flow of the electric motor in the machine system illustrated in FIG. 1.

FIG. 12 is a block diagram of a machine system according to another embodiment.

FIG. 13 is a diagram of an industrial machine according to another embodiment.

FIG. 14 is a block diagram illustrating an example of a control flow of an electric motor in the machine system illustrated in FIG. 12.

FIG. 15 is a block diagram of a machine system according to still another embodiment.

FIG. 16 is a diagram of an industrial machine according to still another embodiment.

FIG. 17 is a block diagram illustrating an example of a control flow of an electric motor in the machine system illustrated in FIG. 15.

FIG. 18 is a block diagram of a machine system according to still another embodiment.

FIG. 19 is a diagram of an industrial machine according to still another embodiment.

FIG. 20 is a block diagram illustrating an example of a control flow of an electric motor in the machine system illustrated in FIG. 18.

### DETAILED DESCRIPTION OF EMBODIMENTS OF THE INVENTION

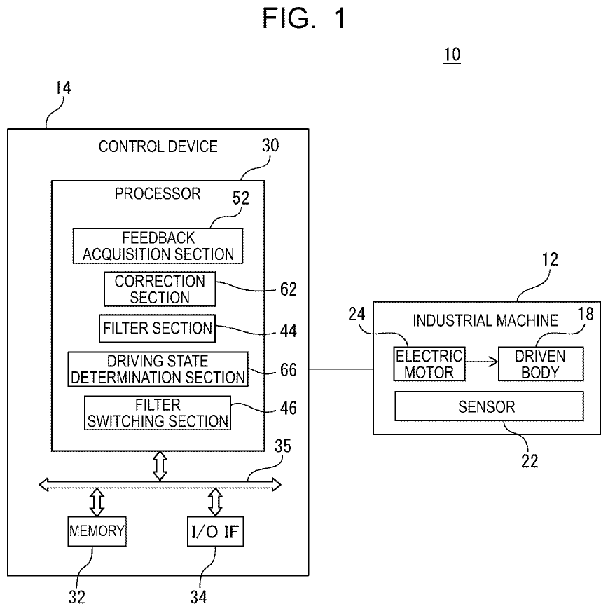

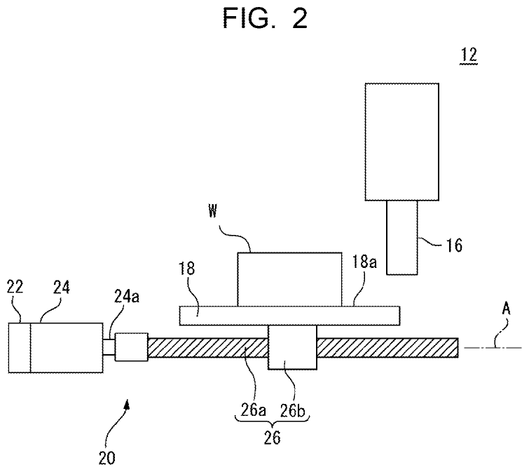

Hereinafter, embodiments of the present disclosure are described in detail with reference to the drawings. In various embodiments described below, the same elements are denoted by the same reference signs, and redundant description will be omitted. First, a machine system 10 according to an embodiment is described with reference to FIG. 1 and FIG. 2. The machine system 10 includes an industrial machine 12 and a control device 14 for controlling the industrial machine 12.

In the present embodiment, the industrial machine 12 is a machine tool that processes a workpiece. Specifically, the industrial machine 12 includes a tool 16, a driven body 18, a movement mechanism 20, and a sensor 22. The movement mechanism 20 relatively moves the tool 16 and the driven body 18. More specifically, the movement mechanism 20 includes an electric motor 24 and a ball screw mechanism 26. The ball screw mechanism 26 includes a ball screw 26a extending straight along an axis line A and a nut member 26b screwed with the ball screw 26a. One end of the ball screw 26a is connected to an output shaft 24a of the electric motor 24.

In the present embodiment, the driven body 18 is a work table having a workpiece installation surface 18a, which is a flat surface, and a workpiece W is set on the workpiece installation surface 18a via a jig (not illustrated). The nut member 26b of the ball screw mechanism 26 is fixed to the driven body 18. The electric motor 24 is, for example, a servo motor, and rotates the ball screw 26a in accordance with a command from the control device 14, thereby reciprocating the driven body 18 along the axis line A.

The sensor 22 is an encoder (or Hall element) or the like for detecting a rotational position (or rotation angle) of the electric motor 24. By time-differentiating the detected rotational position of the electric motor 24, the sensor 22 continuously (e.g., periodically) detects the rotation speed V of the electric motor 24 and sequentially supplies the detected rotation speed V to the control device 14 as a speed feedback value FB_{V}.

The control device 14 is a computer including a processor 30, a memory 32, and an I/O interface 34. The processor 30 is communicably connected to the memory 32 and the I/O interface 34 via a bus 35 and performs arithmetic processing for implementing various functions to be described below while communicating with the memory 32 and the I/O interface 34.

The memory 32 includes a RAM, a ROM, or the like, and temporarily or permanently stores various data. The I/O interface 34 includes, for example, an Ethernet (trade name) port, a USB port, an optical fiber connector, or a HDMI (trade name) terminal and performs wired or wireless data communication with an external device under a command from the processor 30.

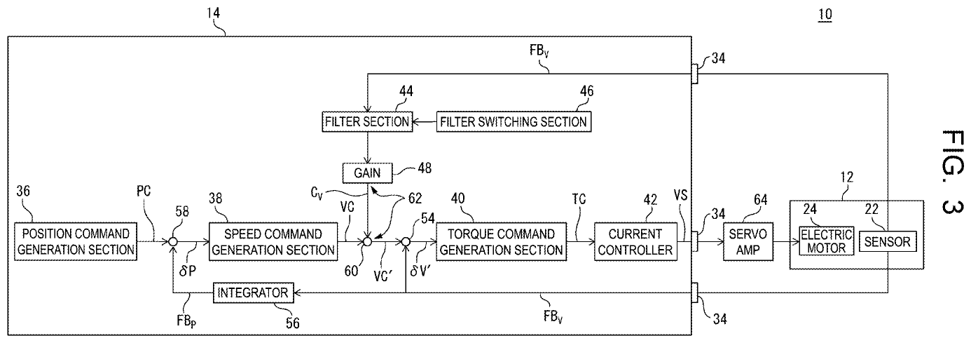

FIG. 3 illustrates a block diagram illustrating a control flow of the electric motor 24. The control device 14 includes a position command generation section 36, a speed command generation section 38, a torque command generation section 40, a current controller 42, a filter section 44, a filter switching section 46 and a gain 48. The processor 30 performs arithmetic processing for implementing functions of the position command generation section 36, the speed command generation section 38, the torque command generation section 40, the current controller 42, the filter section 44, the filter switching section 46 and the gain 48.

Hereinafter, the control flow of the electric motor 24 is described. The processor 30 acquires the speed feedback value FB_{V} from the sensor 22 of the industrial machine 12 via the I/O interface 34. The speed feedback value FB_{V} is time-series data indicating an amplitude value in the rotation speed V of the electric motor 24 in time series.

In this way, in the present embodiment, the processor 30 serves as a feedback acquisition section 52 (FIG. 1) for acquiring the feedback value FB_{V} from the industrial machine 12. The speed feedback value FB_{V} acquired from the sensor 22 is input to a subtractor 54 and an integrator 56. The integrator 56 time-integrates the input speed feedback value FB_{V} and outputs the integrated value to the subtractor 58 as a position feedback value FB_{P}.

The feedback value FB_{V} acquired from the sensor 22 is also input to the filter section 44. The filter section 44 performs filtering on the feedback value FB_{V}. Details of the filtering will be described below. The filter section 44 performs the filtering on the feedback value FB_{V} and outputs the feedback value FB_{V} subjected to the filtering to the gain 48. The gain 48 generates a speed correction value C_{V} by multiplying the speed feedback value FB_{V} output from the filter section 44 by a gain G1 and outputs the speed correction value C_{V} to an adder 60.

When the industrial machine 12 is driven by operating the electric motor 24, the position command generation section 36 generates a position command PC in accordance with an operation program OP and outputs the position command PC to the subtractor 58. The subtractor 58 subtracts the position feedback value FB_{P} from the position command PC and outputs the subtraction result to the speed command generation section 38 as a position deviation δP. The speed command generation section 38 generates a speed command VC based on the positional deviation δP and outputs the speed command VC to the adder 60.

The adder 60 generates a corrected speed command VC′ by adding the speed correction value C_{V} to the speed command VC. In this way, the gain 48 generates the speed correction value C_{V} based on the speed feedback value FB_{V} filtered by the filter section 44, and the adder 60 corrects the speed command VC by the speed correction value C_{V}. Thus, in the present embodiment, the gain 48 and the adder 60 constitute a correction section 62 for correcting the command VC based on the feedback value FB_{V}.

While the industrial machine 12 is driven, the elasticity of components of the industrial machine 12 (e.g., the driven body 18, the ball screw mechanism 26, the output shaft 24a of the electric motor 24) may cause the driven body 18 and the workpiece W to vibrate slightly. In the present embodiment, the correction section 62 is configured to perform correction for canceling such minute vibrations.

The corrected speed command VC′ output from the adder 60 is input to the subtractor 54. The subtractor 54 subtracts the speed feedback value FB_{V} from the corrected speed command VC′ and outputs the subtraction result as a speed deviation δV′. The torque command generation section 40 generates a torque command TC based on the speed deviation δV′ and outputs the torque command TC to the current controller 42.

The current controller 42 generates a voltage signal VS (e.g., a PWM control signal) based on the torque command value TC and transmits the voltage signal VS to a servo amp 64 via the I/O interface 34. The servo amp 64 amplifies the voltage signal VS and inputs the amplified voltage signal VS to the electric motor 24 included in the industrial machine 12. The electric motor 24 drives the driven body 18 (i.e., the workpiece W) in accordance with the input voltage signal VS.

In this document, signals passing through a control line from the position command generation section 36 to the electric motor 24 is defined as “commands” for operating the electric motor 24. Thus, in the present embodiment, the position command PC, the position deviation δP, the speed command VC, the corrected speed command VC′, the speed deviation δV′, the torque command TC, and the voltage signal VS constitute a command for operating the electric motor 24.

Accordingly, the processor 30 generates the commands PC, δP, VC, VC′, δV′, TC, and VS in accordance with the operation program OP and controls the operation of the electric motor 24. Subsequently, the processor 30 drives the industrial machine 12, so that the workpiece W is processed by the tool 16 while the driven body 18 is moved by the operation of the electric motor 24.

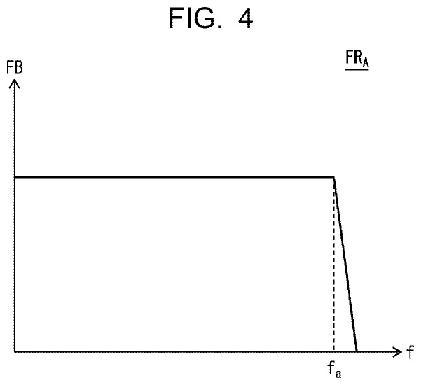

The filter section 44 performs filtering FR for reducing the value in a predetermined frequency band on a feedback value FB (the speed feedback value FB_{V} in the present embodiment) to be supplied to the correction section 62. FIG. 4 illustrates an example of the filtering FR performed by the filter section 44. In filtering FR_{A} illustrated in FIG. 4, the filter section 44 performs filtering (i.e., low-pass filtering) for reducing an amplitude value in a frequency band [f>fₐ], which is higher than a cutoff frequency fₐ, on the feedback value FB.

Note that the filtering FR_{A} by the filter section 44 on the feedback value FB is not limited to the low-pass filtering and may be, for example, band-pass filtering for further reducing the frequency band [f>fₐ] and a specific frequency (or a frequency band) included in a frequency band [f≤fₐ], which is lower than the cutoff frequency fₐ, or notch filtering for reducing a specific frequency (or a frequency band).

This filtering FR_{A} can remove a high-frequency noise component N1 caused by electrical noise or the like from the feedback value FB to be supplied to the correction section 62. Thus, the cutoff frequency fₐ is determined by an operator as a frequency lower than the frequency band of the noise component N1 at which the noise component N1 can be removed.

On the other hand, when the driving state of the industrial machine 12 changes as will be described below, mechanical shock may be applied to the components of the industrial machine 12 (e.g., the driven body 18, the ball screw mechanism 26, the output shaft 24a of the electric motor 24). At this time, the feedback value FB (specifically, the speed feedback value FB_{V}) detected by the sensor 22 includes a noise component N2 caused by the mechanical shock.

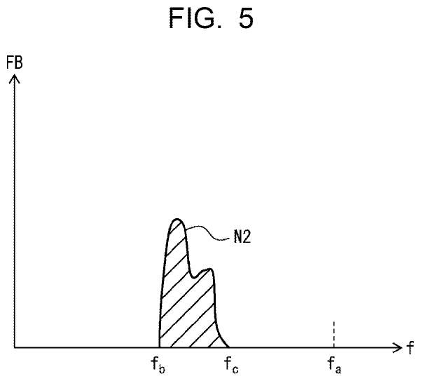

An example of such a noise component N2 is illustrated in FIG. 5. In the example illustrated in FIG. 5, the noise component N2 is distributed in a frequency band from f_{b} to f_{c} lower than the cutoff frequency fₐ of the filtering FR_{A}. Therefore, when such a noise component N2 is included in the feedback value FB, it is not possible to remove the noise component N2 in the filtering FR_{A} described above.

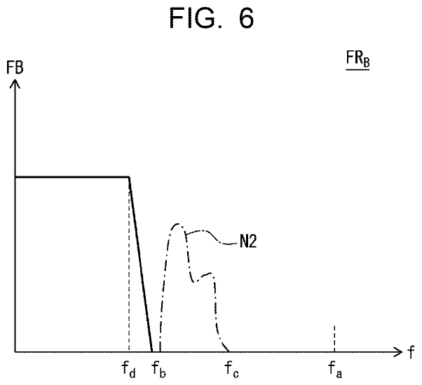

FIG. 6 illustrates an example of filtering FR that can remove such a noise component N2. In filtering FR_{B} illustrated in FIG. 6, the filter section 44 performs filtering (low-pass filtering) for reducing an amplitude value in a frequency band [f>f_{d}] higher than a cutoff frequency fd (fd<fb) on the feedback value FB. This filtering FR_{B} can remove the noise component N2 from the feedback value FB to be supplied to the correction section 62.

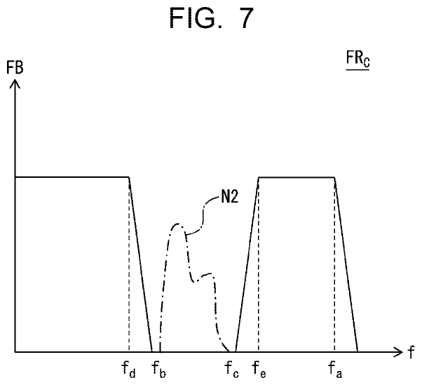

FIG. 7 illustrates another example of filtering FR that can remove the noise component N2. In filtering FR_{C} illustrated in FIG. 7, the filter section 44 performs filtering for reducing an amplitude value in a frequency band [f_{d}<f<fₑ] from the cutoff frequency f_{d} to a cutoff frequency fₑ (f_{c}<fₑ<fₐ) and the frequency band [f>fₐ] higher than the cutoff frequency fₐ with respect to the feedback value FB. Such filtering FR_{C} can be implemented by, for example, a combination of notch filtering for blocking the frequency band [f_{d}<f<fₑ] and low-pass filtering for blocking the frequency band [f>fₐ].

This filtering FR_{C} can remove the noise component N2 from the feedback value FB to be supplied to the correction section 62. The cutoff frequencies f_{d} and fₑ that define the frequency band [f_{d}<f<fₑ] of the filtering FR_{C} can be set by, for example, obtaining the frequency characteristics of the noise component N2 in advance by an experimental method, simulation, or the like.

In the present embodiment, the filter section 44 is configured to perform digital filter (FIR filter, IIR filter, etc.) processing. The filter section 44 performs the filtering FR_{A} by using the feedback value FB and a predetermined filter coefficient α_{A} (tap coefficient, or the like). The filter coefficient α_{A} is a parameter for determining the frequency band [f>fₐ] of the filtering FR_{A}.

Furthermore, the filter section 44 performs the filtering FR_{B} by using the feedback value FB and a predetermined filter coefficient α_{B}. The filter coefficient α_{B} is a parameter for determining the frequency band [f_{d}<f] of the filtering FR_{B}. Furthermore, the filter section 44 performs the filtering FR_{C} by using the feedback value FB and a predetermined filter coefficient α_{C}. The filter coefficient α_{C} is a parameter for determining the frequency band [f_{d}<f<fₑ and fₐ<f] of the filtering FR_{C}.

In the present embodiment, the filter switching section 46 switches the frequency band of the filtering FR from the frequency band [f>fₐ] (first frequency band) of the filtering FR_{A} to the frequency band [f>f_{d}] (second frequency band) of the filtering FR_{B} or the frequency band [f_{d}<f<fₑ and fₐ<f] (second frequency band) of the filtering FR_{C} in response to a change in the driving state of the industrial machine 12.

For example, the filter switching section 46 switches the frequency band f of the filtering FR from the frequency band [f>fₐ] to the frequency band [f>f_{d}] by switching a filter coefficient from the filter coefficient α_{A} (first filter coefficient) corresponding to the frequency band [f>fₐ] of the filtering FR_{A} to the filter coefficient α_{B} (second filter coefficient) corresponding to the frequency band [f>f_{d}] of the filtering FR_{B}.

Alternatively, the filter switching section 46 switches the frequency band f of the filtering FR from the frequency band [f>fₐ] to the frequency band [f_{d}<f<fₑ and fₐ<f] by switching a filter coefficient from the filter coefficient α_{A} to the filter coefficient α_{C} (second filter coefficient) corresponding to the frequency band [f_{d}<f<fₑ and fₐ<f] of the filtering FR_{C}.

Note that, as illustrated in FIG. 6, in the present embodiment, the frequency band [f>f_{d}] of the filtering FR_{B} includes the frequency band f_{d}<f<fₐ lower than the frequency band [f>fₐ] of the filtering FR_{A}. Furthermore, as illustrated in FIG. 7, the frequency band [f_{d}<f<fₑ and fₐ<f] of the filtering FR_{C} includes the frequency band f_{d}<f<fₑ lower than the frequency band [f>fₐ] of the filtering FR_{A}.

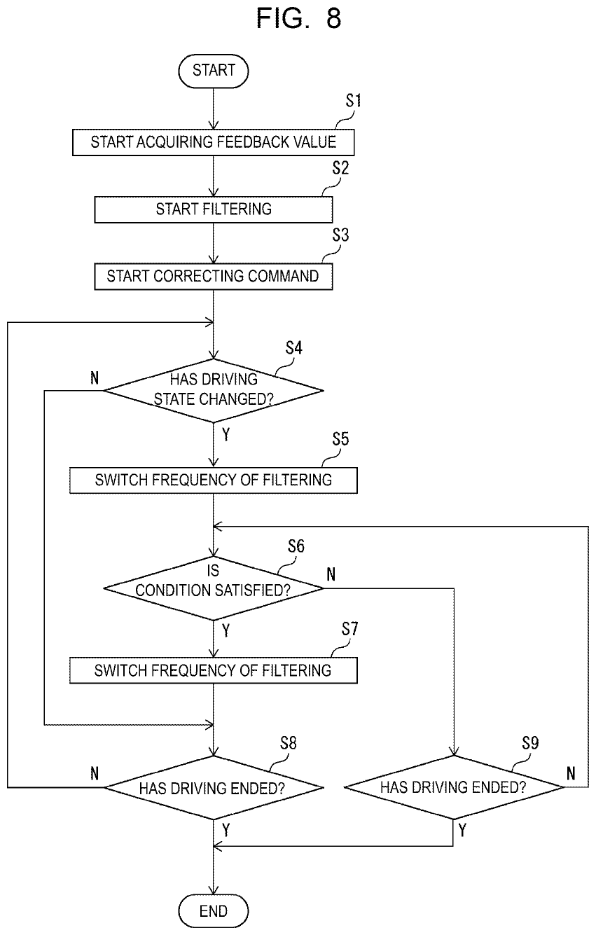

Hereinafter, the filter control flow is described with reference to FIG. 8. The flowchart illustrated in FIG. 8 is started when the processor 30 receives a filter control start command from a host controller, an operator, a computer program, or the like. The filter control start command is transmitted, for example, when the processor 30 starts driving the industrial machine 12.

In step S1, the processor 30 starts acquiring the feedback value FB. Specifically, the processor 30 starts an operation of acquiring the speed feedback value FB_{V} from the sensor 22. In step S2, the processor 30 functions as the filter section 44 and performs the filtering FR_{A} illustrated in FIG. 4 on the feedback value FB. In step S3, the processor 30 functions as the correction section 62 and starts an operation of correcting the command VC with the feedback value FB (the speed feedback value FB_{V} in the present embodiment).

In step S4, the processor 30 determines whether or not the driving state of the industrial machine 12 has changed. As an example, the processor 30 monitors the command PC, δP, VC, VC′, δV′, TC or VS to the electric motor 24 after the start of the flowchart of FIG. 8 and determines that the driving state of the industrial machine 12 has changed, when the command PC, δP, VC, VC′, δV′, TC or VS changes beyond a predetermined threshold value β.

For example, when the tool 16 comes into contact with the workpiece W and starts processing while the industrial machine 12 is driven, the above-described mechanical shock occurs. In this way, when the tool 16 comes into contact with the workpiece W and starts processing, it is regarded that the driving state of the industrial machine 12 has changed. When the tool 16 comes into contact with the workpiece W and starts processing, the torque command TC and the voltage signal VS among the commands to the electric motor 24 can abruptly change (e.g., increase).

Thus, the processor 30 can detect that the processing of the workpiece W has started (i.e., the driving state of the industrial machine 12 has changed) by detecting a change in the torque command TC or the voltage signal VS. In step S4, when the torque command TC or the voltage signal VS changes beyond a threshold value β1, the processor 30 determines that the driving state of the industrial machine 12 has changed (i.e., YES).

When the speed or acceleration of the driven body 18 (i.e., the electric motor 24) with respect to the tool 16 changes abruptly, the above-described mechanical shock can occur. In this way, when the speed or acceleration of the driven body 18 (the electric motor 24) abruptly changes, it is regarded that the driving state of the industrial machine 12 has changed.

When the speed or acceleration of the driven body 18 (the electric motor 24) abruptly changes, the command PC, VC, VC′, TC, or VS to the electric motor 24 can abruptly change. In step S4, when the command PC, VC, VC′, TC, or VS changes beyond a threshold value β2, the processor 30 determines that the driving state of the industrial machine 12 has changed (i.e., YES). Alternatively, the processor 30 may acquire the slope of the command by time-differentiating the command PC, VC, VC′, TC, or VS and determine YES when the slope exceeds a threshold value β3.

As another example, the processor 30 monitors the feedback value FB from the sensor 22 and determines that the driving state of the industrial machine 12 has changed when the feedback value FB changes beyond a predetermined threshold value γ. When the tool 16 comes into contact with the workpiece W and starts processing or when the speed or acceleration of the driven body 18 (the electric motor 24) abruptly changes, the feedback value FB from the sensor 22 can abruptly change. Thus, the processor 30 can detect that the driving state of the industrial machine 12 has changed by detecting a change in the feedback value FB.

Specifically, the processor 30 may determine YES in step S4 when the speed feedback value FB_{V} from the sensor 22 exceeds a predetermined threshold value γ1. Alternatively, the processor 30 may acquire an acceleration feedback value FB_{A} by time-differentiating the speed feedback value FB_{V} and determine YES when the acceleration feedback value FB_{A} exceeds a predetermined threshold value γ2.

Alternatively, the processor 30 may acquire a current feedback value FB_{I} or a load torque and FB_{τ} from the electric motor 24 as the feedback value FB via the I/O interface 34. The processor 30 may determine YES when the current feedback value FBI or the load torque FB_{τ} exceeds a predetermined threshold value γ3.

As still another example, the processor 30 may determine that the driving state of the industrial machine 12 has changed when a drive mode DM of the industrial machine 12 defined by the operation program OP is switched. An example of the drive mode DM is described with reference to Table 1 below.

TABLE 1

| | | |
|---|---|---|
| Operation | G00 | G01 |

Program

| | | |
|---|---|---|
| Drive Mode | Positioning Mode | Processing Mode |

| | | | |
|---|---|---|---|
| Operation | Feeding | Approach | Processing |
| | Operation | Operation | Operation |

In the example illustrated in Table 1 above, the drive mode DM includes a positioning mode defined by an instruction statement “G00” of the operation program OP and a processing mode defined by an instruction statement “G01” of the operation program OP. In the positioning mode, the processor 30 performs a feeding operation for moving the driven body 18 to a work-ready position at a speed V1.

On the other hand, in the processing mode, the processor 30 performs an approach operation for moving the driven body 18 from the work-ready position to a processing start position, in which the tool 16 comes into contact with the workpiece W, at a speed V2 (V2<V1), and subsequently performs a processing operation of processing the workpiece W with the tool 16 while moving the driven body 18. The processor 30 switches the drive mode DM between the positioning mode and the processing mode in accordance with the instruction statements “G00” and “G01” of the operation program OP.

When the drive mode DM is switched from the positioning mode to the processing mode and processing on the workpiece W is started, the above-described mechanical shock occurs. When the drive mode DM is switched in this way, it is regarded that the driving state of the industrial machine 12 has changed. For example, in step S4, the processor 30 determines YES when the drive mode DM is switched from the positioning mode to the processing mode. More specifically, the processor determines YES when receiving the instruction statement “G01” of the operation program OP during the execution of the instruction statement “G00” of the operation program OP.

Alternatively, the processor 30 may also determine YES when a predetermined time t₁ has elapsed after the drive mode DM is switched from the positioning mode to the processing mode. As described above, after the drive mode DM is switched from the positioning mode (instruction statement “G00”) to the processing mode (instruction statement “G01”), the approach operation is performed, subsequently the tool 16 and the workpiece W come into contact with each other, and processing is started. Thus, the tool 16 and the workpiece W actually come into contact with each other when the time t₁ used for the approach operation has elapsed after the drive mode DM is switched from the positioning mode (instruction statement “G00”) to the processing mode (instruction statement “G01”).

In step S4, the processor 30 may count the elapsed time t from the time point when the drive mode DM is switched from the positioning mode to the processing mode and determine YES when the elapsed time t has reached the time t₁. The time t₁ can be predetermined by an operator to match the time used for the approach operation.

Alternatively, the processor 30 sequentially acquires the rotational position of the electric motor 24 detected by the sensor 22 and acquires a distance d that the driven body 18 has moved from the time point when the drive mode DM is switched from the positioning mode to the processing mode, based on the rotational position. In the approach operation described above, the driven body 18 moves a predetermined distance d₁.

In step S4, the processor 30 may determine YES when the drive mode DM is switched from the positioning mode to the processing mode and subsequently the acquired distance d reaches the predetermined threshold value d₁. The threshold value d₁ may be predetermined by an operator to match the distance that the driven body 18 moves in the approach operation.

Another example of the drive mode DM is described with reference to Table 2 below.

TABLE 2

| | | |
|---|---|---|
| Mode Switching | 00 | 01 |
| Signal | | |
| Drive Mode | First Processing Mode | Second Processing Mode |
| Operation | Light Cutting Operation | Heavy Cutting Operation |

In the example illustrated in Table 2, the drive mode DM includes a first processing mode executed when the mode switching signal is “00” (or “OFF”) and a second processing mode executed when the mode switching signal is “01” (or “ON”). The mode switching signal (e.g., a PMC signal) is stored in the memory 32, for example, and is switched between “00” (ON) and “01” (OFF) in synchronization with the operation program OP.

Thus, the first processing mode and the second processing mode are drive modes defined by the operation program OP through the mode switching signal. In the first processing mode, the processor 30 performs a light cutting operation of cutting the workpiece W while pressing the tool 16 against the workpiece W with a force F1 and moving the driven body 18 relative to the tool 16 at a speed V3.

On the other hand, in the second processing mode, the processor 30 performs a heavy cutting operation of cutting the workpiece W with a cutting amount greater than a cutting amount in the light cutting operation while pressing the tool 16 against the workpiece W with a force F2 (F2>F1) and moving the driven body 18 with respect to the tool 16 at a speed V4 (V4>V3). The processor 30 switches the drive mode DM between the first processing mode and the second processing mode depending on whether or not the mode switching signal is “00” or “01”. When the drive mode DM is switched between the first processing mode and the second processing mode, the above-described mechanical shock can occur. When the drive mode DM is switched in this way, it is regarded that the driving state of the industrial machine 12 has changed.

For example, assuming that the first processing mode is executed after the flowchart of FIG. 8 is started, the processor 30 determines YES in step S4 when the drive mode DM is switched from the first processing mode to the second processing mode. More specifically, the processor 30 determines YES when the mode switching signal is switched from “00” to “01”.

On the other hand, assuming that the second processing mode is executed after the flowchart of FIG. 8 is started, the processor 30 determines YES in step S4 when the drive mode DM is switched from the second processing mode to the first processing mode. More specifically, the processor 30 determines YES when the mode switching signal switches from “01” to “00”.

As described above, the processor 30 determines whether or not the driving state of the industrial machine 12 has changed, based on the command (PC, δP, VC, VC′, δV′, TC, or VS) to the electric motor 24, the feedback value FB (FB_{V} or FB_{A}), or the operation program OP of the industrial machine 12. Thus, in the present embodiment, the processor 30 functions as a driving state determination section 66 (FIG. 1) that determines whether or not the driving state of the industrial machine 12 has changed. The processor 30 proceeds to step S5 when determining YES in step S4 and proceeds to step S8 when determining NO.

In step S5, the processor 30 functions as the filter switching section 46 and switches the frequency band of the filtering FR performed by the filter section 44 from the first frequency band to the second frequency band. As an example, the processor 30 switches the frequency band of the filtering FR from the frequency band [f>fₐ] (FIG. 4) of the filtering FR_{A} started in step S2 to the frequency band [f>f_{d}] (FIG. 6) of the filtering FR_{B}. As another example, the processor 30 switches the frequency band of the filtering FR from the frequency band [f>fₐ] of the filtering FR_{A} started in step S2 to the frequency band [f_{d}<f<fₑ and fₐ<f] (FIG. 7) of the filtering FR_{C}.

In this case, the processor 30 may switch the frequency band of the filtering FR from the first frequency band [f>fₐ] to the second frequency band [f>f_{d}] or [f_{d}<f<fₑ and fₐ<f] in a stepwise manner (i.e., discontinuously). For example, when the frequency band of the filtering FR is switched from the first frequency band [f>fₐ] to the second frequency band [f>f_{d}], the processor 30 may switch the cutoff frequency fa of the first frequency band [f>fₐ] to the cutoff frequency f_{d} of the second frequency band [f>f_{d}] in one step, or in n steps (n is a positive number of 2 or more) with a stepwise manner. When the frequency band of the filtering FR is switched from the first frequency band [f>fₐ] to the second frequency band [f_{d}<f<fₑ and fₐ<f], the processor 30 may perform switching in such a manner that the frequency band of f_{d}<f<fₑ is formed in one step or in multi-steps with a stepwise manner.

Alternatively, the processor 30 may switch the frequency band of the filtering FR from the first frequency band [f>fₐ] to the second frequency band [f>f_{d}] or [f_{d}<f<fₑ and fₐ<f] in such a manner that the frequency band continuously changes over time. For example, when the frequency band of the filtering FR is switched from the first frequency band [f>fₐ] to the second frequency band [f>f_{d}], the processor 30 may switch the cutoff frequency fₐ to the cutoff frequency f_{d} in such a manner that the cutoff frequency continuously changes over time.

When the frequency band of the filtering FR is switched from the first frequency band [f>fₐ] to the second frequency band [f_{d}<f<fₑ and fₐ<f], the processor 30 may perform switching in such a manner that the frequency band of f_{d}<f<fₑ is gradually formed (e.g., the frequency band is gradually extended). In this way, by continuously changing the frequency band of the filtering FR, it is possible to prevent mechanical shock from occurring due to the switching of the filtering FR.

In step S6, the processor 30 determines whether or not a predetermined condition CD is satisfied. The condition CD is a condition for re-switching the frequency band [f>f_{d}] or [f_{d}<f<fₑ and fₐ<f] of the filtering FR_{B} or FR_{C} after the switching in step S5 to the frequency band [f>fₐ] of the filtering FR_{A} of step S3.

The noise component N2 caused by the above-described mechanical shock does not continuously occur over a long period of time and may occur instantaneously. Thus, an operator sets the condition CD as a condition under which the effect of the noise component N2 disappears, in order to return the filtering FR to the filtering FR_{A} of step S3 again, after the noise component N2 disappears.

For example, the condition CD can be determined that a predetermined time to has elapsed after the driving state of the industrial machine 12 is changed. In this case, the processor 30 counts, for example, an elapsed time t from the time point when YES is determined in step S4 (or the time point when step S5 starts or ends). Subsequently, when the elapsed time t reaches the predetermined time t₀, the processor 30 determines that the condition CD is satisfied (i.e., YES).

Alternatively, the condition CD may be determined for the command PC, δP, VC, VC′, δV′, TC, or VS to the electric motor 24, or the feedback value FB_{V} or FB_{A} from the sensor 22. For example, when the number of rotations of the electric motor 24 defined by the position command PC (or the movement distance of the driven body 18) reaches a predetermined threshold value, the processor 30 may determine that the condition CD is satisfied (i.e., YES). When the processor 30 determines YES, the procedure proceeds to step S7, whereas when the processor 30 determines NO, the procedure proceeds to step S9.

In step S7, the processor 30 functions as the filter switching section 46 and switches the frequency band of the filtering FR from the second frequency band to the first frequency band. As an example, if the frequency band of the filtering FR has been switched to the frequency band [f>f_{d}] of the filtering FR_{B} in step S5, the processor 30 switches the frequency band [f>f_{d}] to the frequency band [f>fₐ] of the filtering FR_{A}. As another example, if the frequency band of the filtering FR has been switched to the frequency band [f_{d}<f<fₑ and fₐ<f] of the filtering FR_{C} in step S5, the processor 30 switches the frequency band [f_{d}<f<fₑ and fₐ<f] to the frequency band [f>fₐ].

In step S8, the processor 30 determines whether or not the drive of the industrial machine 12 has ended. For example, the processor 30 can determine whether or not the processing of the workpiece W has ended from the operation program OP. The processor 30 determines YES when the processing of the workpiece W has ended, stops the operation of the electric motor 24, and thus ends the drive of the industrial machine 12. Subsequently, the processor 30 ends the flowchart illustrated in FIG. 8. On the other hand, when the processor 30 determines NO, the procedure returns to step S4.

When NO is determined in above-described step S6, the processor 30 determines, in step S9, whether or not the drive of the industrial machine 12 has ended in the same manner as in above-described step S8. When YES is determined, the processor 30 ends the drive of the industrial machine 12 and ends the flowchart illustrated in FIG. 8, and when NO is determined, the procedure returns to step S6.

As described above, in the present embodiment, when the processor 30 determines that the driving state of the industrial machine 12 has changed (YES in step S4), the processor 30 switches the frequency band of the filtering FR from the first frequency band [f>fₐ] to the second frequency band [f>f_{d}] or [f_{d}<f<fₑ and f_{d}<f]. According to this configuration, the second frequency band is set to include the frequency band of the noise component N2 caused by the above-described mechanical shock, and thus the noise component N2 can be removed from the feedback value FB to be supplied to the correction section 62.

On the other hand, when no change in the driving state of the industrial machine 12 is detected (NO is continuously determined in step S4), the processor 30 can remove the high-frequency noise component N1 caused by electric noise or the like from the feedback value FB by performing the filtering FR_{A} on the feedback value FB by the filter section 44.

In conjunction with this, because the filter section 44 causes the feedback value FB to pass over a wide frequency band (f≤fₐ) equal to or less than the cutoff frequency fₐ, the correction section 62 can correct the command VC over a wider frequency band, which makes it possible to enhance the effect of the correction by the correction section 62. In this way, according to the present embodiment, the frequency band of the filtering FR performed by the filter section 44 is switched in response to the driving state of the industrial machine 12, which makes it possible to appropriately perform the correction by the correction section 62.

Furthermore, in the present embodiment, the processor 30 determines whether or not the driving state has changed, based on the command (PC, δP, VC, VC′, δV′, TC, or VS) to the electric motor 24, the feedback value FB (FB_{V} or FB_{A}), or the operation program OP of the industrial machine 12. For example, when the command or the feedback value changes beyond the threshold value β or γ, the processor 30 determines that the driving state has changed.

Alternatively, when the drive mode DM defined by the operation program OP is switched (specifically, at a time point when the drive mode DM is switched, when the predetermined time t₁ has elapsed from the time point, or when the driven body 18 has moved the predetermined distance d₁ after the time point), the processor 30 determines that the driving state has changed. According to this configuration, the timing at which the driving state changes can be determined with high accuracy.

Furthermore, in the present embodiment, the processor 30 functions as the filter section 44 and performs the filtering FR_{A}, FR_{B}, or FR_{C} as digital filtering by using the feedback value FB as well as the filter coefficient α_{A}, α_{B}, or α_{C}, respectively. Subsequently, the processor 30 functions as the filter switching section 46 and switches the frequency band of the filtering FR between the first frequency band [f>fₐ] and the second frequency band [f>f_{d}] or [f_{d}<f<fₑ and fₐ<f] by switching the filter coefficient a among the coefficients α_{A}, α_{B}, and α_{C}. According to this configuration, the processor 30 can quickly and accurately switch the frequency band of the filtering FR.

Furthermore, in the present embodiment, the processor 30 functions as the filter switching section 46, switches the frequency band of the filtering FR to the second frequency band in step S5, and subsequently switches the frequency band from the second frequency band to the first frequency band in accordance with the predetermined condition CD (steps S6 and S7).

According to this configuration, when the driving state of the industrial machine 12 has changed, the noise component N2 can be blocked by performing the filtering FR_{B} or FR_{C}, and the filtering FR_{A} is performed again after the condition CD is satisfied (i.e., after the noise component N2 disappears), so that the effect of the correction by the correction section 62 can be enhanced while removing the high-frequency noise component N1.

Note that steps S6, S7, and S9 may be omitted from the flowchart illustrated in FIG. 8. For example, when the drive mode DM is switched from the first processing mode to the second processing mode as illustrated in Table 2 above while the industrial machine 12 is driven, the processor 30 may proceed to step S8 after step S5 without performing steps S6, S7, and S9, and when NO is determined in step S8, the processor 30 may loop step S8. In this case, the processor 30 continues to perform the filtering FR_{B} or FR_{C} after switching in step S5 until YES is determined in step S8.

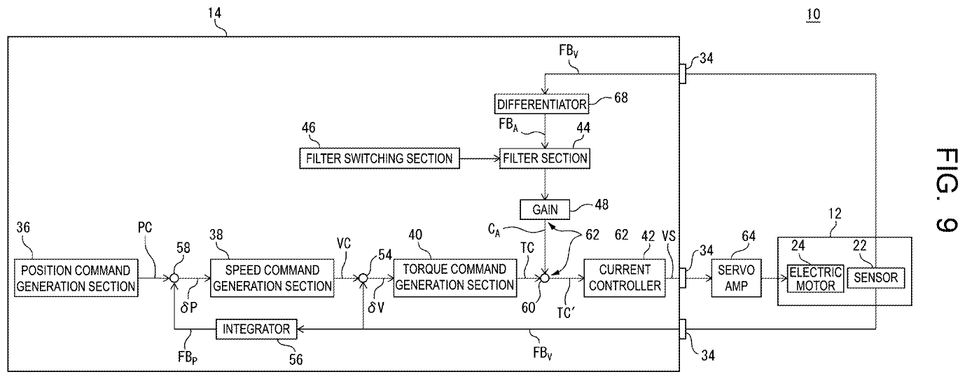

Next, another example of the control flow of the electric motor 24 is described with reference to FIG. 9. In the control device 14 illustrated in FIG. 9, the subtractor 54 subtracts, from the speed command VC output by the speed command generation section 38, the speed feedback value FB_{V} from the sensor 22 and outputs the subtraction result as a speed deviation δV. Subsequently, the torque command generation section 40 generates a torque command TC based on the speed deviation δV.

On the other hand, the speed feedback value FB_{V} acquired from the sensor 22 is input to a differentiator 68. The differentiator 68 time-differentiates the input speed feedback value FB_{V} and outputs the differentiation result to the filter section 44 as an acceleration feedback value FB_{A}. The filter section 44 selectively performs the filtering FR_{A}, FR_{B}, or FR_{C} on the acceleration feedback value FB_{A} as in the above-described embodiment.

In this case, the cutoff frequency fₐ of the filtering FR_{A}, the cutoff frequency f_{d} of the filtering FR_{B}, or the cutoff frequencies f_{d}, fₑ, and fₐ of the filtering FR_{C}, which are performed on the acceleration feedback value FB_{A} by the filter section 44, may be the same cutoff frequencies as in the configuration (i.e., the filtering on the speed feedback value FB_{V}) illustrated in FIG. 3, or may be determined to be a different cutoff frequency unique to the acceleration feedback value FB_{A}.

The filter section 44 performs the filtering FR_{A}, FR_{B}, or FR_{C} on the acceleration feedback value FB_{A} and inputs the acceleration feedback value FB_{A} subjected to the filtering FR_{A}, FR_{B}, or FR_{C} to the gain 48. The gain 48 generates an acceleration correction value C_{A} by multiplying the input acceleration feedback value FB_{A} by a gain and inputs the acceleration correction value C_{A} to the adder 60. The adder 60 generates a corrected torque command TC′ by adding the acceleration correction value C_{A} to the torque command TC generated by the torque command generation section 40. Thus, the gain 48 and the adder 60 constitute the correction section 62 for correcting the torque command TC based on the feedback value FB_{A}.

Also in the configuration illustrated in FIG. 9, the processor 30 performs the flowchart illustrated in FIG. 8 and switches the frequency band of the filtering FR performed by the filter section 44 from the first frequency band [f>fₐ] to the second frequency band [f>f_{d}] or [f_{d}<f<fₑ and fₐ<f] in response to a change in the driving state of the industrial machine 12.

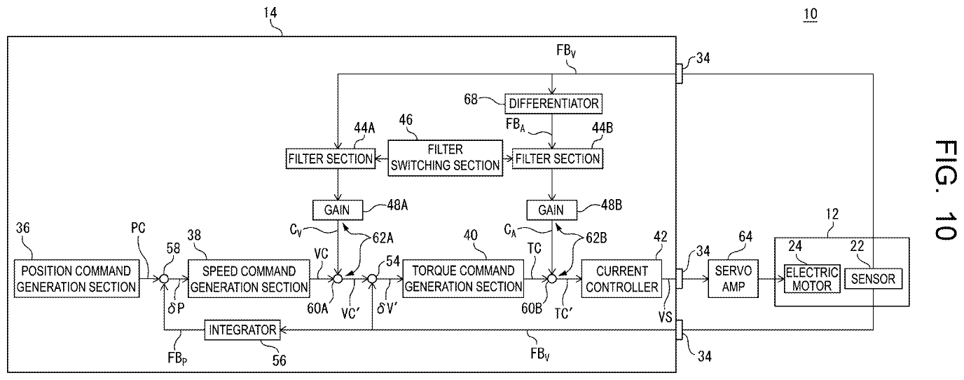

Next, still another example of the control flow of the electric motor 24 is described with reference to FIG. 10. In the configuration illustrated in FIG. 10, the speed feedback value FB_{V} from the sensor 22 is supplied to a filter section 44A in the same manner as in the form illustrated in FIG. 3, is subjected to filtering FR by the filter section 44A, and subsequently is supplied to a correction section 62A including a gain 48A and an adder 60A.

On the other hand, the speed feedback value FB_{V} from the sensor 22 is supplied to a filter section 44B through the differentiator 68 in the same manner as in the form illustrated in FIG. 9, is subjected to filtering FR by the filter section 44B, and subsequently is supplied to a correction section 62B including a gain 48B and an adder 60B. The filter switching section 46 switches frequency bands of the filtering FR performed by the filter sections 44A and 44B.

Also in the configuration illustrated in FIG. 10, the processor 30 performs processing of the flowchart illustrated in FIG. 8 and switches each of the frequency bands of the filtering FR performed by the filter sections 44A and 44B from the first frequency band [f>fₐ] to the second frequency band [f>f_{d}] or [f_{d}<f<fₑ and fₐ<f] in response to a change in the driving state of the industrial machine 12.

Note that a cutoff frequency of the filtering FR (FR_{A}, FR_{B}, or FR_{C}) performed by the filter section 44A on the speed feedback value FB_{V} and a cutoff frequency of the filtering FR (FR_{A}, FR_{B}, or FR_{C}) performed by the filter section 44B on the acceleration feedback value FB_{A} may be the same as or different from each other.

For example, when the filter sections 44A and 44B perform the filtering FR_{A} on the feedback values FB_{V} and FB_{A}, respectively, a cutoff frequency f_{a_A} of the filtering FR_{A} performed by the filter section 44A and a cutoff frequency f_{a_B} of the filtering FR_{A} performed by the filter section 44B may be the same as or different from each other.

Furthermore, when the filter sections 44A and 44B perform the filtering FR_{B} on the feedback values FB_{V} and FB_{A}, respectively, a cutoff frequency f_{d_A} of the filtering FR_{B} performed by the filter section 44A and a cutoff frequency f_{d_B} of the filtering FR_{B} performed by the filter section 44B may be the same as or different from each other.

Furthermore, when the filter sections 44A and 44B perform the filtering FR_{C} on the feedback values FB_{V} and FB_{A}, respectively, cutoff frequencies f_{d_A}, f_{e_A}, and f_{a_A} of the filtering FR_{C} performed by the filter section 44A and cutoff frequencies f_{d_B}, f_{e_B}, and f_{a_B} of the filtering FR_{C} performed by the filter section 44B may be the same as (f_{d_A}=f_{d_B}, f_{e_A}=f_{e_B}, and f_{a_A}=f_{a_B}) or different from each other (f_{d_A}≠f_{d_B}, f_{e_A}≠f_{a_B}, and f_{a_A}≠f_{a_B}).

Furthermore, when the frequency bands of the filter sections 44A and 44B are switched from the first frequency band to the second frequency band in step S5, the processor 30 may cause the second frequency band to be different between the filter sections 44A and 44B. For example, in step S5, the processor 30 may switch the filtering FR performed by the filter section 44A from the filtering FR_{A} to the filtering FR_{B} (or FR_{C}), while switching the filtering FR performed by the filter section 44B from the filtering FR_{A} to the filtering FR_{C} (or FR_{B}).

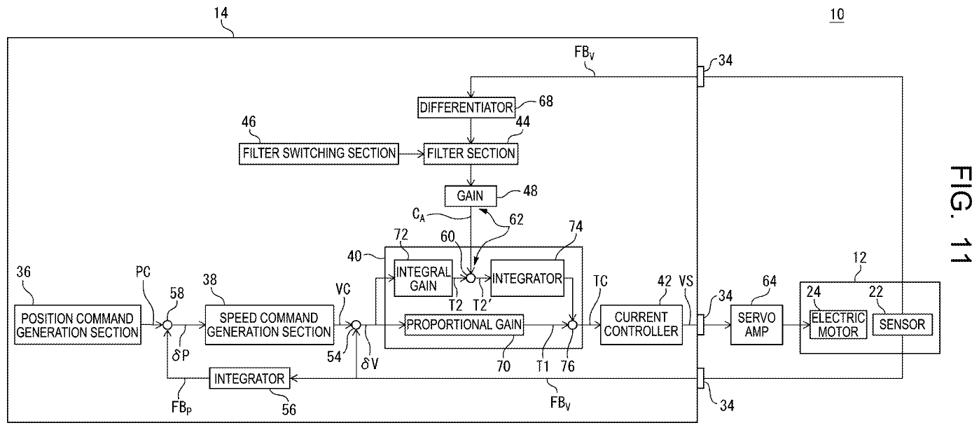

Next, still another example of the control flow of the electric motor 24 is described with reference to FIG. 11. In the configuration illustrated in FIG. 11, the speed feedback value FB_{V} acquired from the sensor 22 passes through the differentiator 68, the filter section 44, and the gain 48 as in the embodiment illustrated in FIG. 9 and is output to the adder 60 as the acceleration correction value C_{A}.

On the other hand, the torque command generation section 40 includes a proportional gain 70, an integral gain 72, and an integrator 74. The proportional gain 70 multiplies the speed deviation δV output from the subtractor 54 by a gain G2 and outputs the multiplication result to an adder 76 as a torque command T1. On the other hand, the integral gain 72 multiplies the speed deviation δV output from the subtractor 54 by a gain G3 and outputs the multiplication result to the adder 60 as a torque command T2.

The adder 60 generates a corrected torque command T2′ by adding the acceleration correction value C_{A} output from the gain 48 to the torque command T2 output from the integral gain 72. The integrator 74 integrates the corrected torque command T2′ and outputs the integration result to the adder 76. The adder 76 generates a torque command TC by adding the corrected torque command T2′ to the torque command T1 output from the proportional gain 70 and outputs the torque command TC to the current controller 42.

The torque commands T1 and T2 and the corrected torque command T2′ constitute the torque command TC for controlling the torque of the electric motor 24, and the torque command TC constitutes a command for operating the electric motor 24 as described above. In this way, in the present embodiment, the correction section 62 includes the gain 48 and the adder 60 and corrects a signal (torque command T2) used for generating the torque command TC in the torque command generation section 40.

Also in the present embodiment, the processor 30 performs the processing of the flowchart illustrated in FIG. 8 and switches the frequency band of the filtering FR performed by the filter section 44 from the first frequency band [f>fₐ] to the second frequency band [f>f_{d}] or [f_{d}<f<fₑ and fₐ<f] in response to a change in the driving state of the industrial machine 12.

Note that the present embodiment has described a case where the correction section 62 corrects the signal T2 used for generating the command TC in the torque command generation section 40; however, the present disclosure is not limited thereto, and the correction section 62 may be configured to correct a signal used for generating the command VC or VS in the speed command generation section 38 or the current controller 42, respectively.

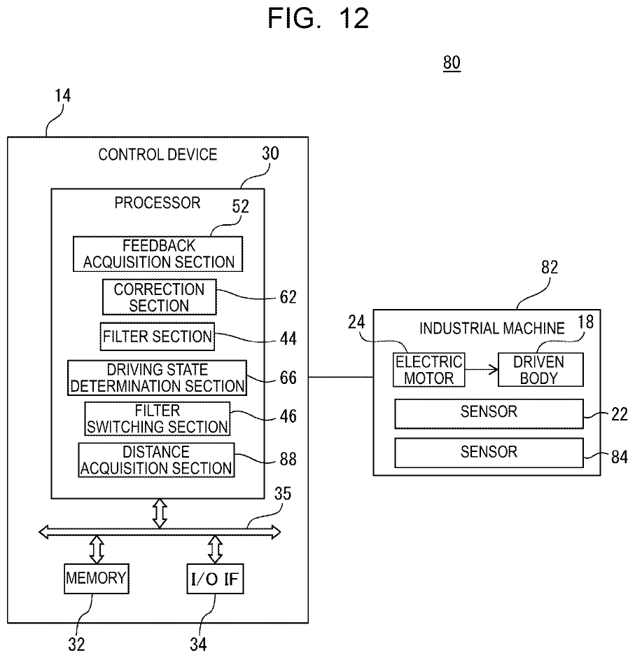

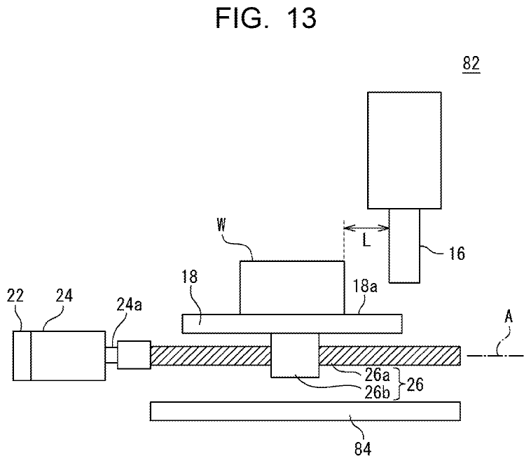

Next, a machine system 80 according to another embodiment is described with reference to FIG. 12 and FIG. 13. The machine system 80 includes an industrial machine 82 and a control device 14 for controlling the industrial machine 82. The industrial machine 82 is different from the above-described industrial machine 12 in that a sensor 84 is further provided.

The sensor 84 is a linear scale, a displacement sensor, or the like, and is disposed to face the driven body 18 (or the workpiece W). The sensor 84 continuously (e.g., periodically) detects a position P (e.g., coordinates) of the driven body 18 (or the workpiece W) in the direction of the axis line A and sequentially transmits the detected position P to the I/O interface 34 of the control device 14 as a position feedback value FB_{P2}.

The processor 30 of the control device 14 functions as the feedback acquisition section 52 and sequentially acquires the position feedback value FB_{P2} from the sensor 84 through the I/O interface 34. The position feedback value FB_{P2} is time-series data indicating the position P of the driven body 18 in time series.

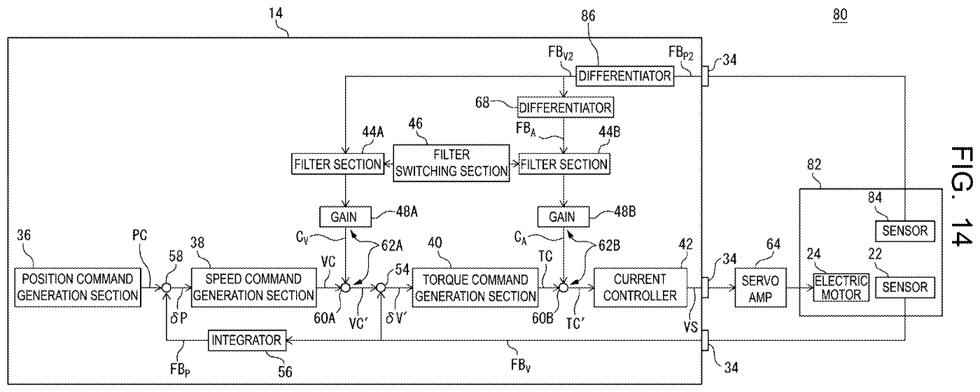

FIG. 14 illustrates an example of a control flow of the electric motor 24 in the machine system 80. The control flow illustrated in FIG. 14 is different from FIG. 10 in the following points. Specifically, the position feedback value FB_{P2} acquired from the sensor 84 is input to a differentiator 86. The differentiator 86 time-differentiates the input position feedback value FB_{P2} and outputs the differentiation result to the filter section 44A and the differentiator 68 as a speed feedback value FB_{V2}.

The speed feedback value FB_{V2} is subjected to the filtering FR by the filter section 44A and subsequently is supplied to the correction section 62A including the gain 48A and the adder 60A in the same manner as in the form illustrated in FIG. 10. The speed feedback value FB_{V2} is time-differentiated by the differentiator 68 is subjected to the filtering FR by the filter section 44B, and subsequently is supplied to the correction section 62B including the gain 48B and the adder 60B.

Next, a filter control flow performed by the processor 30 of the machine system 80 is described with reference to FIG. 8. The flowchart according to the present embodiment is different from the above-described embodiment in step S4. In step S4, the processor 30 determines whether or not the driving state of the industrial machine 82 has changed, based on a distance L between the industrial machine 82 and the workpiece W.

Specifically, the processor 30 obtains the distance L between the industrial machine 82 and the workpiece W based on the position feedback value FB_{P2} acquired from the sensor 84, after the start of step S1. For example, the processor 30 acquires position data of the tool 16 of the industrial machine 82 along with the position feedback value FB_{P2}.

Subsequently, the processor 30 obtains a distance L (FIG. 13) between the tool 16 and the workpiece W from the position data of the tool 16 and the position feedback value FB_{P2}. In this way, in the present embodiment, the processor 30 functions as a distance acquisition section 88 (FIG. 12) for obtaining the distance L based on the feedback value FB_{P2}.

Subsequently, in step S4, the processor 30 functions as the driving state determination section 66 and determines that the driving state of the industrial machine 82 has changed (i.e., YES) when the distance L becomes smaller than a predetermined threshold value ϵ. When the distance L becomes smaller than the predetermined threshold value ϵ, it can be regarded that the tool 16 comes into contact with the workpiece W and starts processing.

Subsequently, in step S5, the processor 30 functions as the filter switching section 46 and switches each of the frequency bands of the filtering FR performed by the filter sections 44A and 44B from the first frequency band [f>fₐ] to the second frequency band [f>f_{d}] or [f_{d}<f<fₑ and fₐ<f].

As described above, in the present embodiment, the processor 30 determines whether or not the driving state of the industrial machine 82 has changed (specifically, the tool 16 comes into contact with the workpiece W), based on the distance L. According to this configuration, the processor 30 can more accurately determine the timing at which the driving state of the industrial machine 82 changes. The processor 30 can switch, at the timing at which a change in the driving state occurs, the frequency band of the filtering FR in each of the filter sections 44A and 44B to the frequency band [f>f_{d}] or [f_{d}<f<fₑ and fₐ<f] in which the noise N2 generated due to the change can be removed.

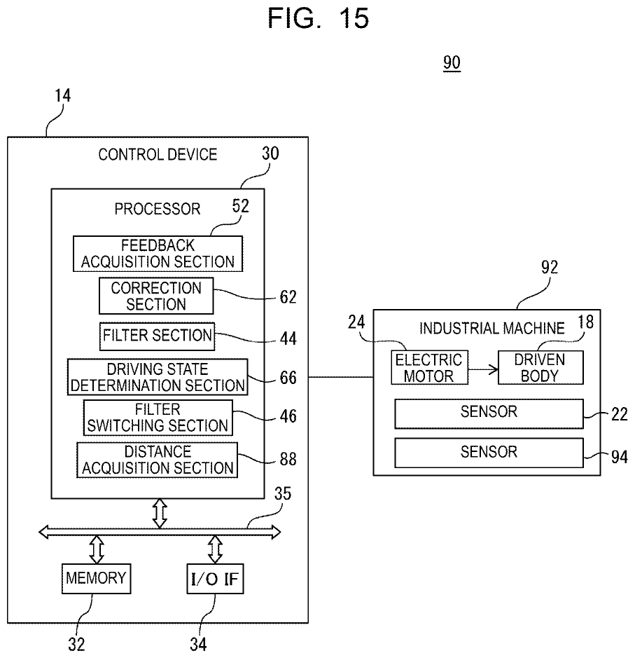

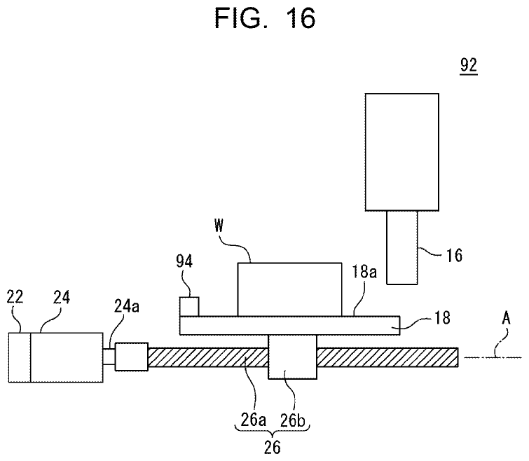

Next, a machine system 90 according to still another embodiment is described with reference to FIG. 15 and FIG. 16. The machine system 90 includes an industrial machine 92 and the control device 14 for controlling the industrial machine 92. The industrial machine 92 is different from the above-described industrial machine 82 in that a sensor 94 is provided.

The sensor 94 is an acceleration sensor and is provided on the driven body 18. The sensor 94 continuously (e.g., periodically) detects the acceleration of the driven body 18 (or the workpiece W) and sequentially transmits the detected acceleration to the I/O interface 34 of the control device 14 as an acceleration feedback value FB_{A2}.

The processor 30 of the control device 14 functions as the feedback acquisition section 52 and sequentially acquires the acceleration feedback value FB_{A2} from the sensor 94 through the I/O interface 34. The acceleration feedback value FB_{A2} is time series data indicating an amplitude value of the acceleration of the driven body 18 in time series.

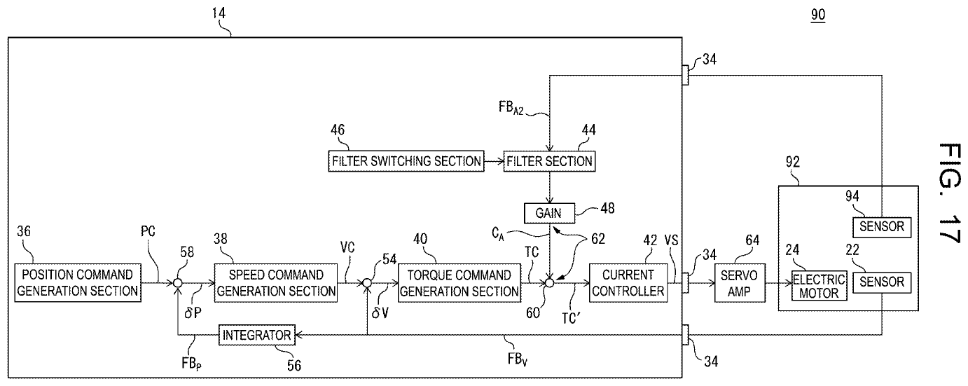

FIG. 17 illustrates an example of a control flow of the electric motor 24 in the machine system 90. The control flow illustrated in FIG. 17 is different from FIG. 9 in the following points. Specifically, the acceleration feedback value FB_{A2} acquired from the sensor 94 is input to the filter section 44. The filter section 44 performs the filtering FR on the acceleration feedback value FB_{A2} and supplies the processing result to the correction section 62 including the gain 48 and the adder 60.

Also in the configuration illustrated in FIG. 17, the processor 30 performs the processing of the flowchart illustrated in FIG. 8 and switches the frequency band of the filtering FR performed by the filter section 44 from the first frequency band [f>fₐ] to the second frequency band [f>f_{d}] or [f_{d}<f<fₑ and fₐ<f] in response to a change in the driving state of the industrial machine 12.

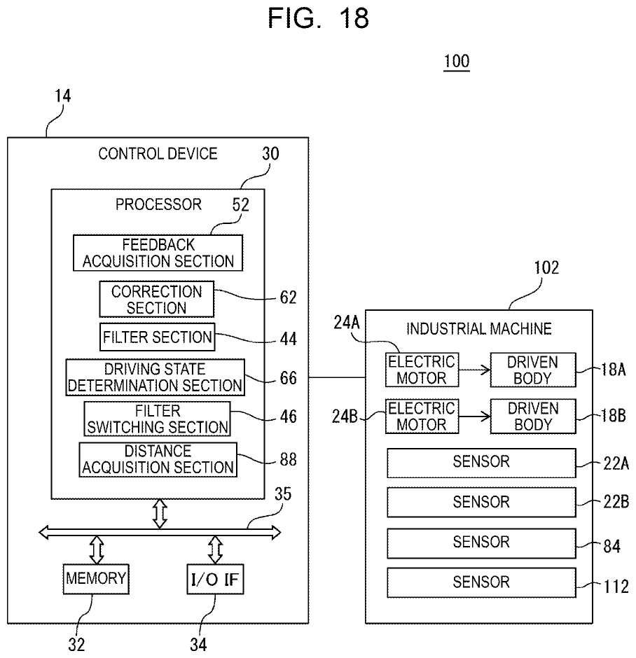

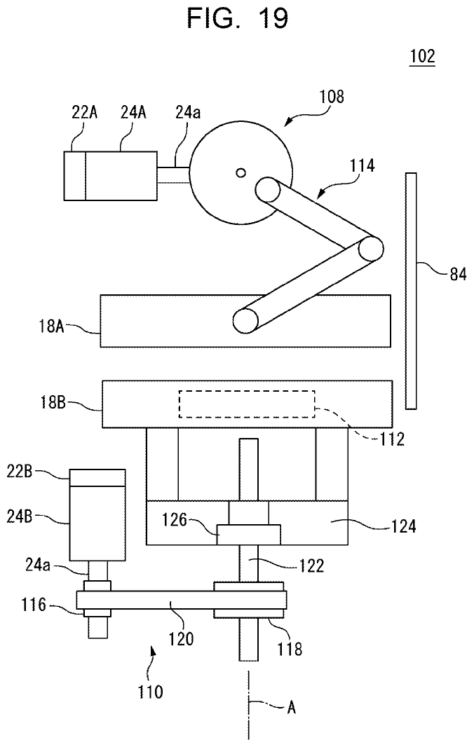

Next, a machine system 100 according to still another embodiment is described with reference to FIG. 18 and FIG. 19. The machine system 100 includes an industrial machine 102 and the control device 14 for controlling the industrial machine 102. The industrial machine 102 is a press machine. Specifically, the industrial machine 102 includes driven bodies 18A and 18B, a first movement mechanism 108, a second movement mechanism 110, and sensors 22A, 22B, 84, and 112.

The driven body 18B is a die cushion of the press machine and is provided to be movable in the direction of the axis line A. A workpiece (not illustrated) is installed on the driven body 18B. On the other hand, the driven body 18A is a slide of the press machine and is disposed above the driven body 18B to be movable in the direction of the axis line A while facing the driven body 18B.

The first movement mechanism 108 includes an electric motor 24A and a crank mechanism 114. The electric motor 24A rotationally drives its output shaft 24a in accordance with a command from the control device 14. The crank mechanism 114 converts rotary motion of the output shaft 24a of the electric motor 24A into reciprocating motion of the driven body 18A in the direction of the axis line A.

The second movement mechanism 110 includes an electric motor 24B, pulleys 116 and 118, a belt 120, a ball screw 122, and a linear moving portion 124. The electric motor 24B rotationally drives its output shaft 24a in accordance with a command from the control device 14. The pulley 116 is fixed to the output shaft 24a of the electric motor 24B and includes teeth formed on its outer circumferential surface. The pulley 118 is fixed to a lower end of the ball screw 122 and includes teeth formed on its outer circumferential surface.

The belt 120 includes teeth formed on its inner circumferential surface and is stretched across the outer circumferential surfaces of the pulleys 116 and 118. The teeth formed on each of the outer circumferential surfaces of the pulleys 116 and 118 and the teeth formed on the inner circumferential surface of the belt 120 engage with each other. This causes the rotational force of the output shaft 24a of the electric motor 24B to be transmitted to the ball screw 122 via the pulleys 116 and 118 and the belt 120, thereby causing the ball screw 122 to rotate about the axis line A. The linear moving portion 124 is installed to be movable in the direction of the axis line A and is fixed to the driven body 18B.

A bolt member 126 is fixedly installed to the center portion of the linear moving portion 124 and the ball screw 122 is screwed with the bolt member 126. As the electric motor 24B rotates the ball screw 122, the bolt member 126 reciprocates, which causes the driven body 18B to reciprocate in the direction of the axis line A.

The sensor 22A is an encoder (or Hall element) or the like for detecting a rotational position of the electric motor 24A. As in the above-described sensor 22, the sensor 22A detects the rotation speed V of the electric motor 24A by time-differentiating the detected rotational position of the electric motor 24A and sequentially supplies the detected rotation speed V to the control device 14 as a speed feedback value FB_{V}.

In the same way, the sensor 22B is an encoder (or Hall element) or the like for detecting a rotational position of the electric motor 24B, and as in the above-described sensor 22, the sensor 22B detects the rotation speed V of the electric motor 24B by time-differentiating the detected rotational position of the electric motor 24B and sequentially supplies the detected rotation speed V to the control device 14 as a speed feedback value FB_{V}.

The sensor 84 is a linear scale, a displacement sensor, or the like, and is disposed to face the driven body 18A. The sensor 84 continuously (e.g., periodically) detects a position P (e.g., coordinates) of the driven body 18A in the direction of the axis line A and sequentially transmits the detected position P to the I/O interface 34 of the control device 14 as a position feedback value FB_{P2}.

The sensor 112 is a force sensor or a pressure sensor and detects a force F3 applied to the driven body 18A by the driven body 18B. Note that, in this document, the force F3 may mean not only force (unit: N) but also pressure (unit: N/m² or Pa). In the present embodiment, the sensor 112 is built into the driven body 18B. The sensor 112 continuously (e.g., periodically) detects the force F3 generated by the driven body 18B and sequentially transmits the detected force F3 to the I/O interface 34 of the control device 14 as a force feedback value FB_{F}.

The processor 30 functions as the feedback acquisition section 52 and sequentially acquires the speed feedback value FB_{V}, the position feedback value FB_{P2}, and the force feedback value FB_{F} through the I/O interface 34. The processor 30 individually controls the electric motors 24A and 24B, moves the driven body 18A downward to sandwich a workpiece installed on the driven body 18B between the driven body 18A and the driven body 18B, and subsequently moves the driven bodies 18A and 18B downward in synchronization with each other to press the workpiece with a mold (not illustrated).

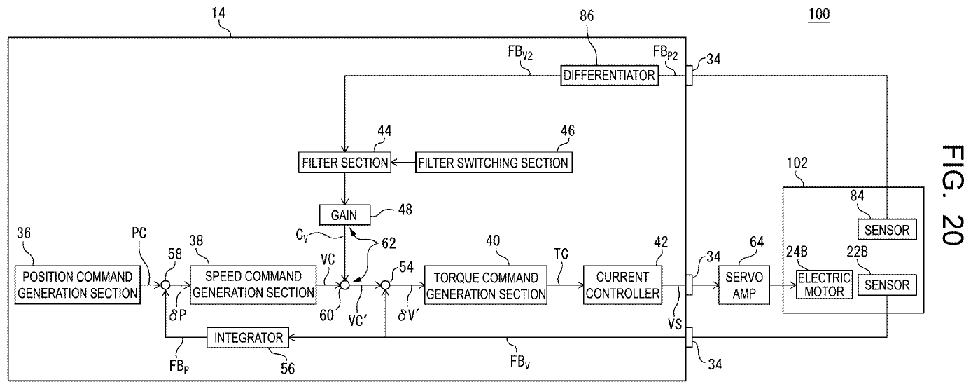

FIG. 20 illustrates an example of a control flow of the electric motor 24B. When the driven bodies 18A and 18B are moved downward while sandwiching the workpiece between the driven bodies 18A and 18B, the processor 30 performs force control to maintain the force F3 at a predetermined target value F_{α}, based on the force feedback value FB_{F} acquired from the sensor 112.

Specifically, the processor 30 generates a force command FC (equal to target value F_{α}). Subsequently, the processor 30 subtracts, from the force command value FC, the force feedback value FB_{F} acquired from the sensor 112 by using a subtractor (not illustrated) and outputs the subtraction result to the speed command generation section 38 as a force deviation δF. Thus, the electric motor 24B moves the driven body 18B downward in synchronization with the driven body 18A while maintaining the force F3 at the target value F_{α}.

On the other hand, the position feedback value FB_{P2} acquired from the sensor 84 is input to the differentiator 86, is time-differentiated by the differentiator 86, and is output to the filter section 44 as a speed feedback value FB_{V2}. The filter section 44 performs the filtering FR on the speed feedback value FB_{V2} and supplies the processing result to the correction section 62 including the gain 48 and the adder 60. The correction section 62 corrects the speed command VC, which is generated by the speed command generation section 38, by the speed correction value C_{V}. In the present embodiment, the correction section 62 is configured to perform correction for reducing the above-described force deviation δF caused by the motion of the driven body 18A.

Next, a filter control flow in the machine system 100 is described with reference to FIG. 8. The processor 30 of the machine system 100 starts acquiring the feedback values FB (the speed feedback value FB_{V}, the position feedback value FB_{P2}, and the force feedback value FB_{F}) in step S1, as in the above-described embodiment, after the start of the flowchart illustrated in FIG. 8. Subsequently, as in the above-described embodiment, the processor 30 starts the filtering FR_{A} by the filter section 44 in step S2 and starts correction of the command VC by the correction section 62 in step S3.

In step S4, the processor 30 determines whether or not the driving state of the industrial machine 12 has changed. As an example, the processor 30 determines YES when the feedback value FB (e.g., the force feedback value FB_{F}, the current feedback value FB_{I}, or the load torque FB value FB_{τ}) changes beyond the predetermined threshold value γ. As another example, when the command (e.g., the torque command TC or the voltage signal VS) to the electric motor 24B changes beyond the threshold value β, the processor 30 determines that the driving state of the industrial machine 12 has changed (i.e., YES).

As still another example, the processor 30 functions as the distance acquisition section 88 and obtains the distance L between the industrial machine 102 and the workpiece, based on the position feedback value FB_{P2} acquired from the sensor 84. Specifically, the processor 30 obtains the distance L between the driven body 18A and the workpiece (or the driven body 18B) from the position feedback value FB_{P2} and the position data of the driven body 18B. Subsequently, the processor 30 determines YES when the distance L is less than the predetermined threshold value ϵ.

Subsequently, in step S5, the processor 30 switches the frequency band of the filtering FR from the first frequency band [f>fₐ] to the second frequency band [f>f_{d}] or [f_{d}<f<fₑ and fₐ<f]. The cutoff frequency fₐ of the filtering FR_{A}, the cutoff frequency fa of the filtering FR_{B}, or each of the cutoff frequencies f_{d}, fₑ, and fₐ of the filtering FR_{C}, which are performed by the filter section 44 illustrated in FIG. 20, may be the same cutoff frequency as that in the form illustrated in FIG. 3 or FIG. 9 or may be determined to be a different cutoff frequency unique to the machine system 100.

Subsequently, the processor 30 sequentially performs steps S6 to S9 as in the above-described embodiment. In this way, also in the machine system 100, when the driving state of the industrial machine 12 has changed, the noise component N2 can be blocked from the feedback value FB_{V2} by the filtering FR_{B} or FR_{C}. It should be understood that the control flow as illustrated in FIG. 3, FIG. 9, FIG. 10, FIG. 11, FIG. 14, or FIG. 17 can be applied as the control flow of the electric motor 24A or 24B.

In the above-described embodiments, the filter switching section 46 may determine, when switching the frequency band of the filtering FR, the frequency band [f>f_{d}] of the filtering FR_{B} or the frequency band [f_{d}<f<fₑ and fₐ<f] of the filtering FR_{C} based on the command PC, δP, VC, VC′, δV′, TC, or VS to the electric motors 24, 24A, or 24B or the feedback values FB from the sensors 22, 22A, 22B, 84, 94, or 112.

For example, the processor 30 may generate a learning model LM indicating the correlation between the command to the electric motor or the feedback value FB from the sensor and the frequency characteristics of the noise component N2 and determine the frequency band of the filtering FR based on the command or the feedback value FB and the learning model LM.

Hereinafter, an example of a learning method of the learning model LM will be described. The processor 30 repeatedly attempts to drive the industrial machine 12 so that the driving state of the industrial machine 12 changes and acquires, as a learning data set DS, time change characteristics or frequency characteristics of a command or feedback value FB acquired at this time and the frequency characteristics (frequency band) of a noise component N2 generated in the feedback value FB.

Subsequently, the processor 30 generates the learning model LM indicating the correlation between the command or feedback value and the frequency characteristics of the noise component N2 by performing, for example, supervised learning by using the learning data set DS. The processor 30 executes a learning cycle for acquiring the learning data set DS and updating the learning model LM each time the processor 30 repeatedly attempts to drive the industrial machine 12. This makes it possible to guide the learning model LM to an optimal solution.

Subsequently, in above-described step S5, the processor 30 inputs, to the learning model LM, the command or feedback value acquired when the driving state has changed. By so doing, the learning model LM outputs the frequency characteristics of the noise component N2 having a correlation with the command or feedback value when the driving state changes. The processor 30 can determine the frequency bands (i.e., the cutoff frequencies f_{d}and fₑ) of the filtering FR_{B} and FR_{C} to include the output frequency band of the noise component N2. Accordingly, the processor 30 can determine the frequency band of the filtering FR based on the command to the electric motor or the feedback value FB from the sensor.

Note that the frequency characteristics of the filtering FR_{A}, FR_{B}, and FR_{C} illustrated in FIGS. 4, 6, and 7, respectively, are examples, and may be configured to have any frequency characteristics in accordance with a noise component to be blocked. Furthermore, the above-described industrial machine 12 may include a plurality of movement mechanisms for moving the driven body 18 in a plurality of directions. In this case, the processor 30 may execute the above-described filter control flow on electric motors of respective movement mechanisms. Furthermore, the position command generation section 36 may be deleted from the above-described embodiments. In this case, the position command generation section 36 may be provided in a host controller, and the processor 30 may receive the position command PC from the host controller.

Furthermore, the above-described embodiments have described a case where in step S4 of FIG. 8, the processor 30 (the driving state determination section 66) determines whether or not the driving state of the industrial machine 12 has changed based on the command (PC, δP, VC, VC′, δV′, TC, or VS) to the electric motor 24, the feedback value FB (FB_{V} or FB_{A}), or the operation program OP of the industrial machine 12.

However, the embodiment is not limited thereto, and the processor 30 may estimate, for example, a time t_{V} at which the driving state changes (e.g., the industrial machine 12 and the workpiece come into contact with each other) and determine YES in step S4 when the elapsed time from the start of the driving reaches the time t_{V}. This time t_{V} can be estimated from the operation program, for example.

Furthermore, the above-described embodiments have described a case where the filter section 44 is configured as a digital filter. However, the filter section 44 may be configured by an analog filter. For example, the filter section 44 may also include an analog filter section 44α that can perform the filtering FR_{A}, an analog filter section 44β that can perform the filtering FR_{B}, or an analog filter section 44γ that can perform the filtering FR_{C}.

The processor 30 may switch the frequency band of the filtering FR by switching between the analog filter section 44α and the analog filter section 44β or 44γ. Although the present disclosure is described above through the embodiments, the above-described embodiments do not limit the invention according to the claims.

### REFERENCE SIGNS LIST

10, 80, 90, 100 Machine system

12, 82, 92, 102 Industrial machine

14 Control device

22, 22A, 22B, 84, 94, 112 Sensor

24, 24A, 24B Electric motor

30 Processor

44, 44A, 44B, 44α, 44β, 44γ Filter section

46 Filter switching section

20 62, 62A, 62B Correction section

66 Driving state determination section

88 Distance acquisition section

1. A control device configured to control an electric motor of an industrial machine, the control device comprising:
a feedback acquisition section configured to acquire a feedback value from the industrial machine driven by an operation of the electric motor;
a correction section configured to correct a command for operating the electric motor, based on the feedback value;
a filter section configured to perform filtering for reducing a value in a predetermined frequency band on the feedback value to be supplied to the correction section;
a driving state determination section configured to determine whether or not a driving state of the industrial machine is changed; and
a filter switching section configured to switch the frequency band of the filtering to be performed by the filter section from a first frequency band to a second frequency band, when the driving state determination section determines that the driving state is changed.

2. The control device of claim 1, wherein the driving state determination section is configured to determine whether or not the driving state is changed, based on the command, the feedback value, or an operation program for the industrial machine.

3. The control device of claim 2, wherein the driving state determination section is configured to determine that the driving state is changed, when the command or the feedback value changes beyond a predetermined threshold value.

4. The control device of claim 3, wherein
the command includes a torque command to the electric motor, and
the driving state determination section is configured to determine that the driving state is changed when the torque command is greater than the threshold value.

5. The control device of claim 2, further comprising a distance acquisition section configured to acquire a distance between the industrial machine and a workpiece, based on the feedback value, wherein
the driving state determination section is configured to determine that the driving state is changed when the distance is less than a predetermined threshold value.

6. The control device of claim 2, wherein the driving state determination section is configured to determine that the driving state is changed when a drive mode of the industrial machine, which is defined by the operation program, is switched.

7. The control device of claim 1, wherein the filter section is configured to perform the filtering, using the feedback value and a predetermined filter coefficient, and
the filter switching section is configured to switch the frequency band from the first frequency band to the second frequency band by switching the filter coefficient from a first filter coefficient corresponding to the first frequency band to a second filter coefficient corresponding to the second frequency band.

8. The control device of claim 1, wherein the filter switching section is configured to switch the frequency band from the first frequency band to the second frequency band in a stepwise manner or in such a manner that the frequency band continuously changes over time.

9. The control device of claim 1, wherein the second frequency band includes a frequency band lower than the first frequency band.

10. The control device of claim 1, wherein the filter switching section is configured to, after switching the frequency band of the filtering, switch the frequency band from the second frequency band to the first frequency band in accordance with a predetermined condition.

11. A machine system comprising:
the control device of claim 1; and
the industrial machine including the electric motor and a sensor configured to acquire the feedback value and supply the feedback value to the control device.

12. A method of controlling an electric motor of an industrial machine, the method comprising:
acquiring a feedback value from the industrial machine driven by an operation of the electric motor;
correcting a command for operating the electric motor, based on the feedback value;
performing filtering for reducing a value in a predetermined frequency band on the feedback value used for the correcting;
determining whether or not a driving state of the industrial machine is changed; and
switching the frequency band of the filtering to be performed from a first frequency band to a second frequency band, when determining that the driving state is changed.
